(19) United States
(12) Patent Application Publication
(10) Pub. No.: US 2006/0209427 A1
(43) Pub. Date: Sep. 21, 2006

(54) Electrostatic actuator and image pickup apparatus using the same

(75) Inventors: Toshikatsu Akiba, Chiba-ken (JP); Akihiro Koga, Tokyo (JP); Kyoya Matsuda, Kanagawa-ken (JP); Futoshi Ishii, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/377,191

(22) Filed: Mar. 17, 2006

(30) Foreign Application Priority Data
Mar. 17, 2005 (JP) 2005-077073

(51) Int. Cl. H02N 1/00; H04N 5/225; G02B 15/14

(52) U.S. Cl. 359/694; 310/309; 348/374

(57) ABSTRACT

An image pickup apparatus includes a stator frame, a driving electrode substrate patterned with a polyphase stator electrode and mounted to the stator frame, a holding electrode substrate patterned with a stator electrode and mounted to the stator frame oppositely to the driving electrode substrate, a plurality of movable sections movably provided between the driving electrode substrate and the holding electrode substrate, and a holder mounted so as to project out beyond an outer surface of at least one of the plural movable sections for holding a lens in the movable section.

### CROSS-REFERENCE TO RELATED APPLICATIONS

This application is based upon and claims the benefit of priority from the prior Japanese Patent Application No. 2005-077073, filed Mar. 17, 2005, the entire contents of which are hereby incorporated herein by reference.

### BACKGROUND OF THE INVENTION

1. Field of the Invention

The present invention relates to an electrostatic actuator. The present invention also relates to an image pickup apparatus using the electrostatic actuator in a driving mechanism for achieving an autofocus function and/or a zooming function of a camera.

2. Description of the Background Art

Recently, an image pickup apparatus having an autofocus function and/or a zooming function has been mounted in mobile devices such as a cellular phone. In such an image pickup apparatus, a lens is driven for adjusting focus and/or a zooming magnification to finally form an image on a sensor. An electrostatic actuator is sometimes used as a driving source for driving the lens in a direction of an optical axis (refer to Japanese Patent Application (KOKAI) No. 2001-346385 and Japanese Patent Application No. (KOKAI) 2002-199747).

In an electrostatic actuator, a substrate is provided on a first surface inside a hollow stator, for example. A polyphase stator electrode is provided on the substrate. The polyphase stator electrode is patterned for driving a movable section in a predetermined direction. Another substrate is provided on the second surface inside the hollow stator opposing the first surface inside a frame of the hollow stator. A rotor electrode is provided on the substrate. The rotor electrode is patterned so as to generate drawing power for separating a movable section from the polyphase stator electrode. A movable section is inserted between both the electrode substrates. On the movable section, a movable section electrode is formed having an uneven shape and corresponding to the polyphase stator electrode.

A voltage is applied between the stator electrode and the movable section. This causes electrostatic power between the stator electrode and the movable section. The electrostatic power is used for drawing the movable section to generate power for driving the movable section (driving power). In the case of use as an electrostatic actuator in an image pickup apparatus, providing a lens in the movable section to arrange an order of application of the voltage to the polyphase rotor electrode enables the drawing power to be used as the driving power of the lens.

In the electrostatic actuator having such a structure, stopping application of the driving voltage causes extinction of a drawing operation for the movable section. Accordingly, stopping application of the driving voltage allows the movable section to move freely. A shock due to vibrations or a fall when the application of the driving voltage is stopped may cause an acceleration by which the movable section moves in a space in the hollow stator. The movable section may then hit against an optical filter or a fixed lens on a sensor surface, for example, in moving in the space. This may cause damage to the optical component.

### SUMMARY OF THE INVENTION

In view of the above, an object of the present invention is to provide a novel electrostatic actuator capable of reducing a shock such as due to vibrations or a fall, and to have excellent shock resistance.

To achieve the above object, according to an aspect of the invention, a novel electrostatic actuator includes: a stator frame; a driving electrode substrate mounted on the stator frame and including driving electrodes; a holding electrode substrate mounted on the stator frame facing the driving electrode substrate so as to form an inner space with the driving electrode substrate and including a stator electrode; and a movable member configured to move in the inner space between the driving electrode substrate and the holding electrode substrate, wherein the movable member includes a lens and a holder holding the lens, and that projects out beyond an outer surface of the movable member.

Further, in accordance with another aspect of the invention, a novel electrostatic actuator includes: a stator frame; a driving electrode substrate mounted on the stator frame and including driving electrodes; a holding electrode substrate mounted on the stator frame facing the driving electrode substrate so as to form an inner space with the driving electrode substrate and including a stator electrode; and a plurality of movable members to move in the inner space between the driving electrode substrate and the holding electrode substrate, wherein at least one of the plurality of movable member includes a lens and a holder holding the lens, and that projects out beyond an outer surface of the movable member.

Moreover, in accordance with another aspect of the invention, a novel image pickup apparatus includes: the electrostatic actuator; and an optical sensor for detecting an image, wherein the lens forms the image on the optical sensor.

An electrostatic actuator capable of easily reducing a shock such as vibrations and a fall and that is excellent in shock resistance and an image pickup apparatus using the same can be thus obtained.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a partially cut-off image pickup apparatus using an electrostatic actuator in a first embodiment of the invention;

FIG. 2 is an exploded perspective view of an image pickup apparatus using an electrostatic actuator in a first embodiment of the invention;

FIGS. 3(a) to 3(c) are simplified views schematically showing a zooming lens unit (an electrostatic actuator) in a first embodiment of the invention;

FIG. 4 is a simplified view showing a schematic structure of a movable section of an electronic actuator in a first embodiment of the invention;

FIG. 5 is a simplified view showing a schematic structure of a movable section of an electronic actuator in a second embodiment of the invention;

FIG. 6 is a simplified view showing a schematic structure of a movable section of an electronic actuator in a third embodiment of the invention;

FIG. 7 is a simplified view showing a schematic structure of a movable section of an electronic actuator in a fourth embodiment of the invention; and

FIG. 8 is a simplified view showing a schematic structure of a movable section of an electronic actuator in a fifth embodiment of the invention.

### DETAILED DESCRIPTION OF THE PREFERRED EMBODIMENTS

Embodiments of the invention will be described in detail hereinafter, with reference to the drawings, in which like reference numerals indicate corresponding elements throughout the views.

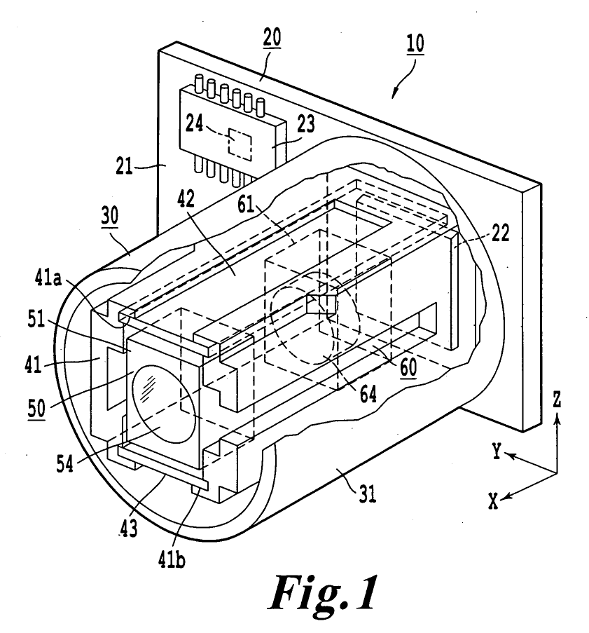

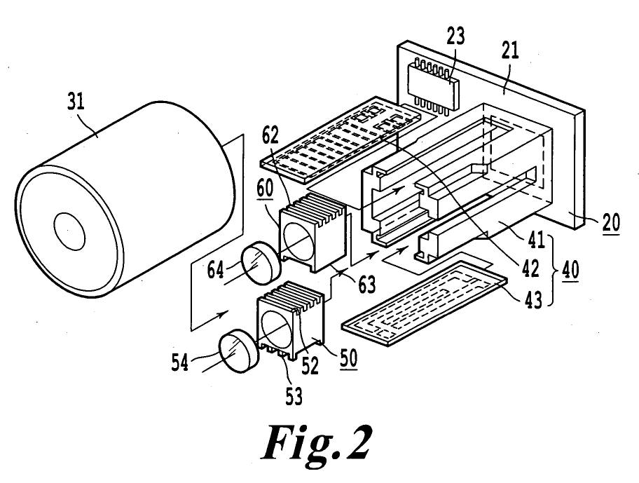

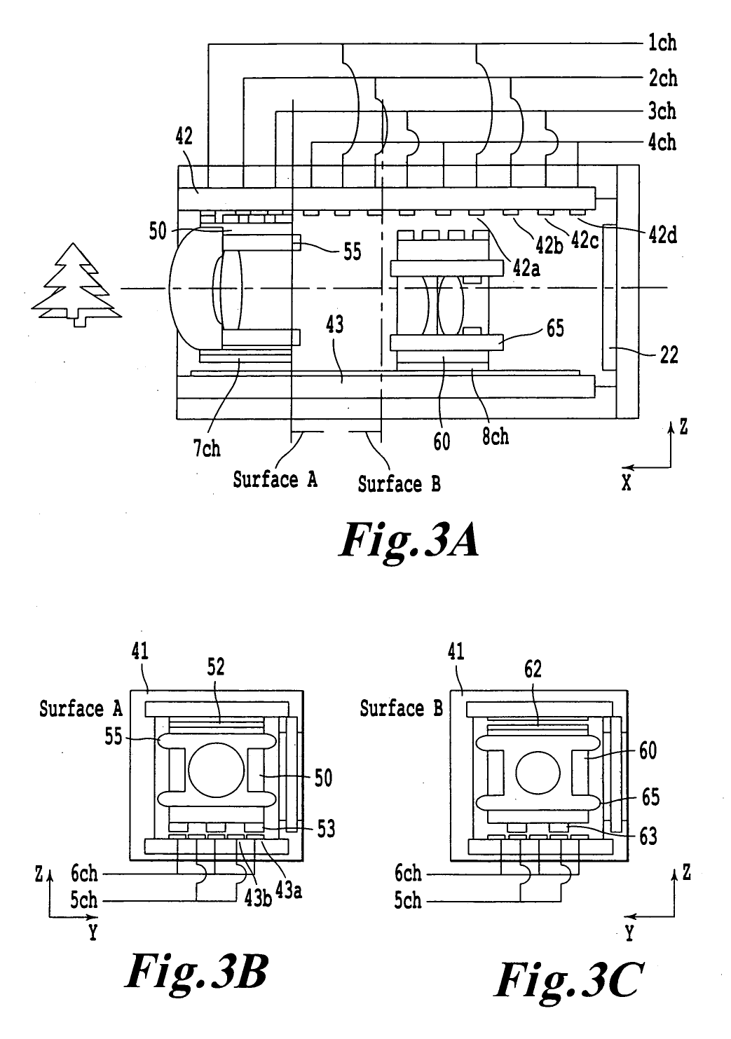

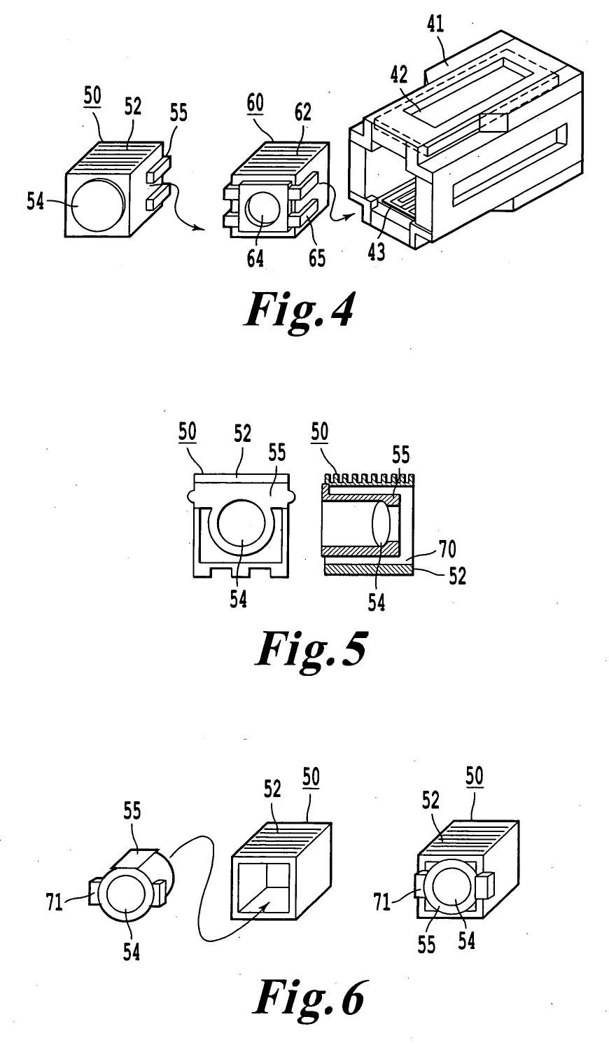

FIG. 1 is a perspective view of a partially cut-off image pickup apparatus 10 using an electrostatic actuator in a first embodiment of the invention. FIG. 2 is an exploded perspective view showing the image pickup apparatus 10. FIGS. 3(a) to 3(c) are simplified views schematically showing a zooming lens unit (an electrostatic actuator) 30. FIG. 4 is a simplified view showing a schematic structure of a movable section of an electronic actuator in the embodiment. Arrows X, Y and Z in the drawings denote three directions crossing each other at right angles. Especially, the arrow X is a pass-through direction of a pass-through of a stator frame. That is to say, the arrow X denotes a moving direction (a predetermined direction) of first and second movable sections 50 and 60, which corresponds to an optical axis direction of lenses 54 and 64 held in the movable sections 50 and 60. In the description of the embodiment, a direction shown by the arrow Z in FIG. 1 is an upward direction for the purpose of description.

The image pickup apparatus 10 detects an image of a subject to be picked up, the image being formed by the lenses 54 and 64 provided in the zooming lens unit 30. The image pickup apparatus 10 includes an optical sensor 20 and the zooming lens unit 30. The optical sensor 20 includes a substrate 21, a sensor 22 such as a CCD, and an electronic component 23 for control, the sensor 22 and the electronic component 23 being provided on the substrate 21. A driving control circuit 24 is built in the electronic component 23.

The zooming lens unit 30 includes a cylindrical cover 31, a stator 40, the first movable section 50, and the second movable section 60. The first and second movable sections 50 and 60 are inserted in a stator frame 41 of stator 40 so as to be separated from each other, and are movable in the optical axis direction X.

The stator 40 includes a stator frame 41, which is a hollow rectangular parallelepiped frame having a pass-through part. The stator frame 41 has an upper inner surface 41a and a lower inner surface 41b. A driving electrode substrate 42 is mounted on the upper inner surface 41a. The driving electrode substrate 42 is patterned with driving electrodes for driving the first and second movable sections 50 and 60. A holding electrode substrate 43 is mounted on the lower inner surface 41b facing the driving electrode substrate 42 so as to form an inner space with the driving electrode substrate 42. The holding electrode substrate 43 is patterned with a stator electrode for generating drawing power for separating the movable sections 50 and 60 from the driving electrodes. The stator electrode on holding electrode substrate 43 also operates as a holding electrode for holding the movable sections 50 and 60 at their set positions.

Patterning a surface of an insulating material substrate with a predetermined electrode configuration forms the driving electrode substrate 42. On the driving electrode substrate 42, the driving electrodes 42a to 42d are provided in parallel of plural electrode groups extending in the direction Y orthogonal to the moving direction X, as shown in FIG. 3(a). The insulating material substrate can be formed of a glass plate, a silicon wafer provided on its surface with a thermally oxidized film, or an insulating substrate for a print wiring board such as aramid and glass epoxy, for example. The width of the respective electrodes is from around several μm to several ten μm while a space between the respective electrodes is from around several μm to several ten μm. The respective electrodes are arranged with a fixed interval. The fixed interval in the above context includes a margin of process error occurring in processing the components.

The driving electrodes 42a to 42d are connected to the driving control circuit 24 of the electronic component 23. A controlling voltage signal is input from the driving control circuit 24 to drive the driving electrodes 42a to 42d. That is to say, the voltage signal is independently applied to the driving electrodes 42a to 42d of the respective groups. In the case of applying a voltage to the driving electrode 42a, for example, the voltage signal is applied to all electrodes corresponding to the driving electrode 42a on the driving electrode substrate 42. In the embodiment, the driving electrode 42a corresponds to a channel 1 (ch1), the driving electrode 42b corresponds to a channel 2 (ch2), the driving electrode 42c corresponds to a channel 3 (ch3), and the driving electrode 42d corresponds to a channel 4 (ch4).

Patterning a surface of an insulating material substrate with a predetermined electrode configuration allows the holding electrode substrate 43 to be formed. On the holding electrode substrate 43, a stripe electrode 43a (a first stator electrode) corresponding to a first movable section electrode 53 of the first movable section 50 and a stripe electrode 43b (a second stator electrode) corresponding to a second movable section electrode 63 (described later) of the second movable section 60 are formed in parallel in the pass-through direction, as shown in FIGS. 3(a), 3(c). The insulating material substrate can be a glass plate, a silicon wafer provided on its surface with a thermally oxidized film, or an insulating substrate for a print wiring board such as aramid and glass epoxy, for example. In the embodiment, the stripe electrode 43b for the second movable section corresponds to a channel 5 (ch5) while the stripe electrode 43a for the first movable section corresponds to a channel 6 (ch6). The stripe electrodes 43a and 43b are electrically independently provided so as to be able to individually control the first and second movable sections 50 and 60.

The first movable section 50 includes a substantially rectangular parallelepiped holding body 51 having a hollow part and formed from a conductive material. Physically grinding or chemically etching a conductive material, for example, allows the holding body 51 to be formed. The holding body 51 may be formed by molding, such as injection molding of conductive resin. A movable section side driving electrode 52 is formed on an upper surface of the holding body 51. On a lower surface of the holding body 51 is formed on a first movable section electrode 53. Further, the lens 54 is fixed to the hollow part through a later-mentioned holder 55.

The movable section side driving electrode 52 includes a protruded stripe extending so as to cross the moving direction X of the first movable section 50 at right angles. The stripe forms convex and concave parts arranged in parallel in the moving direction X. An interval between the convex parts is around 32 μm, for example. The height of the convex part is about 10 μm from a bottom surface of the concave part. The height should be at least 10 μm and may be deeper than 10 μm. The width of the convex part of the movable section side driving electrode 52 is substantially equal to an interval of the driving electrode substrates 42a to 42d. The width of the concave bottom surface of the movable section side driving electrode 52 is substantially equal to an interval of the driving electrode substrates 42a to 42d. In the case of using a silicon wafer in which a thermally oxidized film is formed on a surface of the driving electrode substrate 42, for example, the convexes or the concaves of the movable side driving electrode 52 are arranged with an interval of about 64 μm.

The first movable section electrode 53 extends in the moving direction X of the first movable section 50 and includes a protruded stripe formed by etching so as to be arranged in parallel in the direction Y. The first movable section electrode 53 corresponds to a channel 7 (ch7).

The second movable section 60 includes a substantially rectangular parallelepiped holding body 61 having a hollow part and formed from a conductive material. Physically grinding or chemically etching a conductive material, for example, allows the holding body 61 to be formed. The holding body 61 may be formed by molding, such as injection molding of conductive resin. A movable section side driving electrode 62 is formed on an upper surface of the holding body 61. A second movable section electrode 63 is formed on a lower surface of the holding body 61. Further, the lens 64 is fixed to the hollow part through a later-mentioned holder 65.

The movable section side driving electrode 62 includes a protruded stripe formed by etching and extending so as to cross the moving direction X of the second movable section 60 at right angles. The stripe forms convex and concave parts arranged in parallel in the moving direction X. An interval between the convex parts is around 32 μm, for example. The height of the convex part is about 10 μm from a bottom surface of the concave part. The height should be at least 10 μm and may be deeper than 10 μm. The width of the convex part of the movable section side driving electrode 62 is substantially equal to an interval of the driving electrode substrates 42a to 42d. The width of the concave bottom surface of the movable section side driving electrode 62 is substantially equal to an interval of the driving electrode substrates 42a to 42d. In the case of using a silicon wafer in which a thermally oxidized film is formed on a surface of the driving electrode substrate 42, for example, the convexes or the concaves of the movable side driving electrode 62 are arranged with an interval of about 64 μm.

The second movable section electrode 63 extends in the moving direction X of the first movable section 50 and includes a protruded stripe formed by etching so as to be arranged in parallel in the direction Y. The second movable section electrode 63 corresponds to a channel 8 (ch8).

The above-mentioned lens 54 of the first movable section 50 and the lens 64 of the second movable section 60 can be repositioned in arrangement. Then, a lens system of the lenses 54 and 64 is zoomed between a wide side and a tele-side and a subject to be picked up is focused on.

A zooming lens unit is exemplified in the embodiment. The invention, however, is applicable to a lens unit provided with one movable section and having an autofocus function as well as a zooming lens unit including three or more movable sections. In the case of the lens unit provided with one movable section and having an autofocus function, a holding electrode substrate 43 patterned with a stator electrode generating drawing power for separating the movable section 50 from the driving electrodes is mounted to a lower inner surface 41b of the stator frame 41.

In the pickup apparatus 10 having such a structure, the first and second movable sections 50 and 60 are driven as described below.

In the first movable section 50, a potential difference is provided between the driving electrodes 42a to 42d and the movable section side electrode 52 and between the stripe electrode 43a and the first movable section electrode 53. This causes power in the drawing direction by electrostatic power between the driving electrodes 42a to 42d and the movable section side electrode 52 and between the stripe electrode 43a and the first movable section electrode 53. Switching the driving electrodes 42a to 42d and the stripe electrode 43a between which potential difference is provided in known methods (Paragraphs 0037 to 0049 of JP-A-2004-126009, for example) allows the location of the first movable section 50 to be moved.

On the other hand, a potential difference is provided between the driving electrodes 42a to 42d and the movable section side electrode 62 and between the stripe electrode 43b and the second movable section electrode 63 in the second movable section 60. This causes power in the drawing direction by electrostatic power between the driving electrodes 42a to 42d and the movable section side electrode 62 and between the stripe electrode 43b and the second movable section electrode 63. Similarly to the case of the first movable section 50, switching the driving electrodes 42a to 42d and the stripe electrode 43b between which potential difference is provided in known methods allows the location of the second movable section 60 to be moved.

In the case of holding the first movable section 50, a potential difference is provided between the stripe electrode 43a and the first movable section 53. This causes power in the drawing direction by electrostatic power between the stripe electrode 43a and the first movable section electrode 53, so that the first movable section 50 can be held. In the case of holding the second movable section 60, a potential difference is provided between the stripe electrode 43b and the second movable section 63 similarly to the case of the first movable section 50.

In the above-mentioned electrostatic actuator, the movable sections 50 and 60 in the embodiment are provided with holders 55 and 65, to hold respective lenses 54, 64, that protrude from end surfaces of the movable sections, the end surfaces being provided in a direction crossing the optical direction (the moving direction), as shown in FIGS. 3(a) to 3(c) and 4, for example. The lenses 54 and 64 are respectively held in the movable sections 50 and 60 through the holders 55 and 65. The movable sections 50 and 60 are formed from metal superior in processing precision to improve driving power. In this case, however, a shock due to vibrations or a fall may damage components. For the purpose of preventing the above, a material such as urethane and rubber, for example, which is softer than metal, can be used as the material of the holders 55 and 65. This enables a structure for absorbing a shock in the event of a collision of the movable sections to be realized. Further, it then also becomes possible to hold the lenses 54 and 64 in the respective holders 55, 65 with pressure. This can reduce an error in assembly of the center of the optical axis of the lens.

Moreover, as shown in FIGS. 3(b) and 3(c), the holders 55 and 65 are arranged to also project from the side surfaces of the movable sections 50 and 60 to function as a shock absorber in the direction crossing the optical axis direction. In addition, the holders 55 and 65 can be used as a guide rail of the stator frame 41. That is to say, arranging the holders 55 and 65 so as to project as mentioned above allows a structure of the stator frame 41 to be simplified.

As described above, a structure that the holders 55 and 65, which are formed from a material softer than metal and provided so as to project from the outlines of the movable sections 50 and 60, hold the lenses 54 and 64 provides an electrostatic actuator capable of easily reducing a shock such as from vibrations and a fall and that has excellent shock resistance.

Now, modified embodiments of a structure of a movable section of an electrostatic actuator in accordance with the invention are described. It goes without saying that the modified embodiments are used in the above-mentioned image pickup apparatus 10.

FIG. 5 is a simplified view showing a schematic structure of a movable section of an electronic actuator in a second embodiment of the invention. In FIG. 5, a modification of the movable section 50 in the first embodiment is shown. The structure in FIG. 5, however, is also applicable to the movable section 60.

In the second embodiment, the holder 55 is provided on the inner surface of the movable section 50 through a space 70. In accordance with such a structure, influence on a main body of the movable section 50 can be reduced even in the case that the holder 55 is deformed when the lens 54 is inserted with pressure. That is to say, according to the second embodiment, the precision in shape of the movable section can be more easily secured.

FIG. 6 is a simplified view showing a schematic structure of a movable section of an electronic actuator in a third embodiment of the invention. In FIG. 6, a modification of the movable section 50 in the first embodiment is shown. The structure in FIG. 6, however, is also applicable to the movable section 60.

As shown in FIG. 6, a side projection part 71 is arranged so that a part projecting from an end surface of the holder 55 would simply extend in the direction crossing the projecting direction. Such a structure also allows an operational effect similar to that of the first embodiment to be achieved.

FIG. 7 is a simplified view showing a schematic structure of a movable section of an electronic actuator in a fourth embodiment of the invention. In FIG. 7, a modification of the movable section 50 in the first embodiment is shown. The structure in FIG. 7, however, is also applicable to the movable section 60.

As shown in FIG. 7, holder projections 72 are provided in a holder part. The holder projections 72 are fitted to an end surface holding member 73, which is a separate component, to form the holder 55. The holder 55 is inserted into the movable section 50. A part of the end surface holding member 73 is then bent along the side surfaces of the movable section 50 to fix the holder 55 in the movable section 50. An absorber, which is a side surface projection part 74, may be provided on the bent part. According to such a structure, an operational effect similar to that of the first embodiment can be achieved. In the fourth embodiment, the end surface holding member 73 can be formed from metal to be processed, so that the precision in shape at a holding location can be improved.

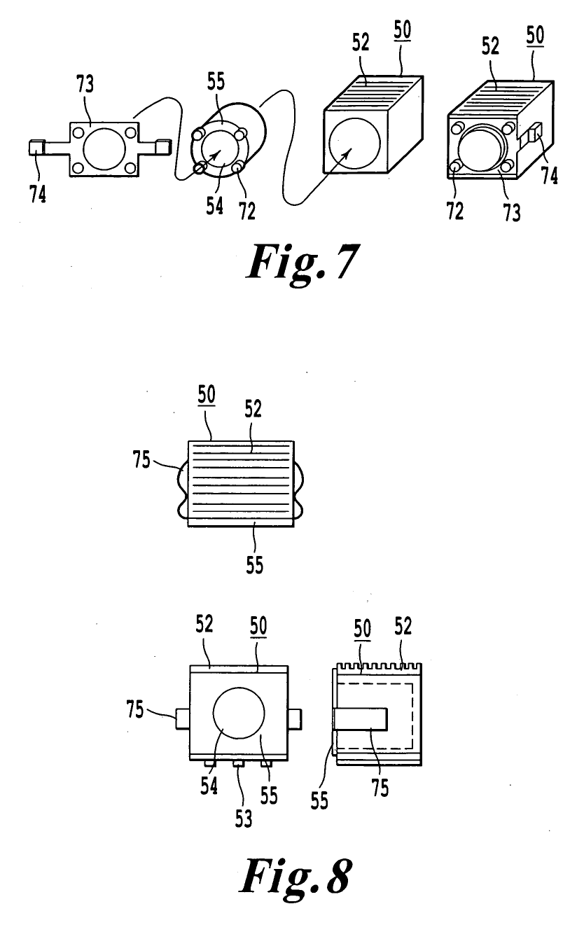

FIG. 8 is a simplified view showing a schematic structure of a movable section of an electronic actuator in a fifth embodiment of the invention. In FIG. 8, a modification of the movable section 50 in the first embodiment is shown. The structure in FIG. 8, however, is also applicable to the movable section 60.

As shown in FIG. 8, the part of the end surface holding member 73, which is bent along the side surfaces in the fourth embodiment, is formed into the shape of a wave board to provide a wave-shaped projection part 75 in the fifth embodiment. In accordance with such a structure, deformation of the wave-shaped projection part 75 in collision enables a shock to be absorbed. Accordingly, it is not necessary to provide the side projection part 74 provided in the fourth embodiment. This contributes to a reduction in costs by being able to omit a manufacturing process and reduce a number of members.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electrostatic actuator comprising:
a stator frame;
a driving electrode substrate mounted on the stator frame and including driving electrodes;
a holding electrode substrate mounted on the stator frame facing the driving electrode substrate to form an inner space with the driving electrode substrate, and including a stator electrode; and
a movable member configured to move in the inner space between the driving electrode substrate and the holding electrode substrate,
wherein the movable member includes,
a lens, and
a holder holding the lens, and that projects out beyond an outer surface of the movable member.

2. The electrostatic actuator according to claim 1, wherein the lens is held in the holder with pressure.

3. The electrostatic actuator according to claim 1, wherein the holder is provided on an inner surface of the movable member via a space.

4. The electrostatic actuator according to claim 1, wherein the holder projects from an end surface crossing the moving direction of the movable member and further projects from a side surface of the movable member.

5. The electrostatic actuator according to claim 1, wherein the holder is formed from a material softer than metal.

6. An electrostatic actuator comprising:
a stator frame;
a driving electrode substrate mounted on the stator frame and including driving electrodes;
a holding electrode substrate mounted on the stator frame facing the driving electrode substrate so as to form an inner space with the driving electrode substrate, and including a stator electrode; and
a plurality of movable members configured to move in the inner space between the driving electrode substrate and the holding electrode substrate,
wherein at least one of the plurality of movable member includes,
a lens, and
a holder holding the lens, and that projects out beyond an outer surface of the movable member.

7. The electrostatic actuator according to claim 6, wherein the stator electrode is further configured to hold the movable member at a position.

8. The electrostatic actuator according to claim 6, wherein the lens is held in the holder with pressure.

9. The electrostatic actuator according to claim 6, wherein the holder is provided on an inner surface of the movable member via a space.

10. The electrostatic actuator according to claim 6, wherein the holder projects from an end surface crossing the moving direction of the movable member and further projects from a side surface of the movable member.

11. The electrostatic actuator according to claim 6, wherein the holder is formed from a material softer than metal.

12. An image pickup apparatus comprising:
a stator frame;
a driving electrode substrate mounted on the stator frame and including driving electrodes;
a holding electrode substrate mounted on the stator frame facing the driving electrode substrate to form an inner space with the driving electrode substrate, and including a stator electrode;
a first movable member configured to move in the inner space between the driving electrode substrate and the holding electrode substrate; and
an optical sensor for detecting an image,
wherein the first movable member includes,
a first lens to form the image on the optical sensor, and
a first holder holding the lens, and that projects out beyond an outer surface of the movable member.

13. The image pickup apparatus according to claim 12, wherein the first lens is held in the first holder with pressure.

14. The image pickup apparatus according to claim 12, wherein the first holder is provided on an inner surface of the first movable member via a space.

15. The image pickup apparatus according to claim 12, wherein the first holder projects from an end surface crossing the moving direction of the first movable member and further projects from a side surface of the first movable member.

16. The image pickup apparatus according to claim 12, wherein the first holder is formed from a material softer than metal.

17. An image pickup apparatus according to claim 12, further comprising:
a second movable member configured to move in the inner space between the driving electrode substrate and the holding electrode substrate;
wherein the second movable member includes,
a second lens to form the image on the optical sensor, and
a second holder holding the lens, and that projects out beyond an outer surface of the second movable member.

18. An electrostatic actuator comprising:
a stator frame;
a driving electrode substrate mounted on the stator frame and including driving electrodes;
a holding electrode substrate mounted on the stator frame facing the driving electrode substrate to form an inner space with the driving electrode substrate, and including a stator electrode; and
a movable member configured to move in the inner space between the driving electrode substrate and the holding electrode substrate,
wherein the movable member includes,
a lens, and
means for holding the lens, and that projects out beyond an outer surface of the movable member.
